(19) United States
(12) Patent Application Publication
(10) Pub. No.: US 2016/0264269 A1
(43) Pub. Date: Sep. 15, 2016

(54) DEVICE FOR SEPARATING CAN LIDS

(71) Applicant: Red Bull GmbH, Fuschl am See (AT)

(72) Inventor: Stephanie SCHWEIGKOFLER, Fuschl am See (AT)

(73) Assignee: Red Bull GmbH, Fuschl am See (AT)

(21) Appl. No.: 15/062,802

(22) Filed: Mar. 7, 2016

(30) Foreign Application Priority Data
Mar. 10, 2015 (AT) A 50191/2015

(51) Int. Cl. B65B 7/28; B65G 59/06

(52) U.S. Cl. CPC B65B 7/2807; B65G 59/06

(57) ABSTRACT

Method of closing an open container (15) with a can lid (3) to obtain a closed can (12) and a device (1) for separating can lids (3) disposed in a stack by means of a separator blade (4), the device comprising at least one suction device (5) for aspirating particles occurring on the can lids (3) during the process of separating the cans.

The invention relates to a device for separating can lids disposed in a stack by means of a separator blade.

The invention further relates to a method of closing an open container with a can lid to obtain a closed can, whereby in a step i), a lowermost can lid in a stack of can lids is picked up and separated from the stack by means of a separator blade and in a step ii), the separated can lid is conveyed by means of at least one conveyor device to a device for closing the open container with the can lid, and in a step iii) the container is connected to the can lid to obtain the can.

A device and a method of the type outlined above are known from EP0934219B1, for example. The disadvantage of the known device and the known method is that when separating the can lid, abrasions can be left on the can lids and can therefore lead to contamination of the can contents by particles on the can lids.

Accordingly, the objective of the invention is to overcome the aforementioned disadvantage of the prior art.

This objective is achieved by the invention by means of a device of the type outlined above, the device having at least one suction device for aspirating from the can lids particles released during the process of separating the can lid.

The solution proposed by the invention offers a simple way of freeing the separated can lid of contamination and keeping it that way.

Based on one advantageous embodiment of the invention, at least one suction orifice of the at least one suction device may be disposed at least partially above or below the separator blade, as viewed in a vertical direction, or at the same height as the separator blade.

In the case of one embodiment which enables very efficient aspiration of the can lid, the separator blade may be provided in the form of a disk mounted so as to rotate about an axis, and at least a portion of the suction orifice overlaps at least a peripheral region of the disk as viewed in a direction parallel with the axis.

In order to collect the aspirated particles to enable the particles aspirated from the cans to be analyzed, the at least one suction device has a collecting container for aspirated particles.

The aforementioned objective may also be achieved by means of a method of the type outlined above whereby in step i) or between step i) and step ii), particles on the can lids released during the separation process by the separator blade are aspirated from at least one surface of the lowermost can lid in the stack.

The method proposed by the invention enables any abrasions which occur to be aspirated directly from the point at which they occur.

Based on another advantageous embodiment of the invention, in step i), particles released during the process of separating the can lid by means of the separator blade can be aspirated from a gap between the lowermost can lid in the stack and the next can lid in the stack.

This offers a very efficient way of removing particles from both the bottom face and the top face of a can lid.

However, to prevent particles disposed on the can lid from getting into the interior of the can during a closing operation, particles can be aspirated from at least the bottom face of the lowermost can lid in the stack in step i).

Based on one embodiment of the invention, the particles can also be aspirated from the can lids after the separation process. With this embodiment, after step i), particles can be aspirated from at least the bottom face of the can lid separated in step i).

In another advantageous embodiment of the method proposed by the invention, the particles aspirated in or after step i) can be collected in a collecting container. This offers a simple way of preventing contamination of the atmosphere in which the cans are closed. Furthermore, the collected particles can then be analyzed.

In the case of another embodiment of the method proposed by the invention, particles collected in the collecting container are analyzed. This makes it possible to ascertain what materials are on the can lids and it can then be determined whether materials foreign to the process are also on the can lids. This offers better monitoring and quality control of the production process.

To provide a clearer understanding, the invention will be explained in more detail with reference to the appended drawings.

These are highly simplified, schematic diagrams illustrating the following:

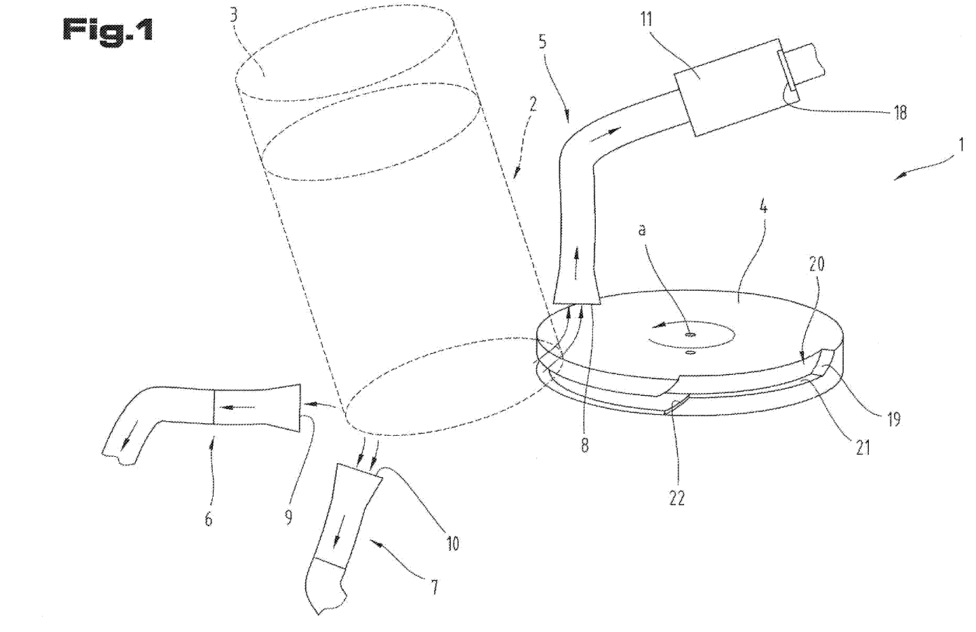

FIG. 1 a device proposed by the invention;

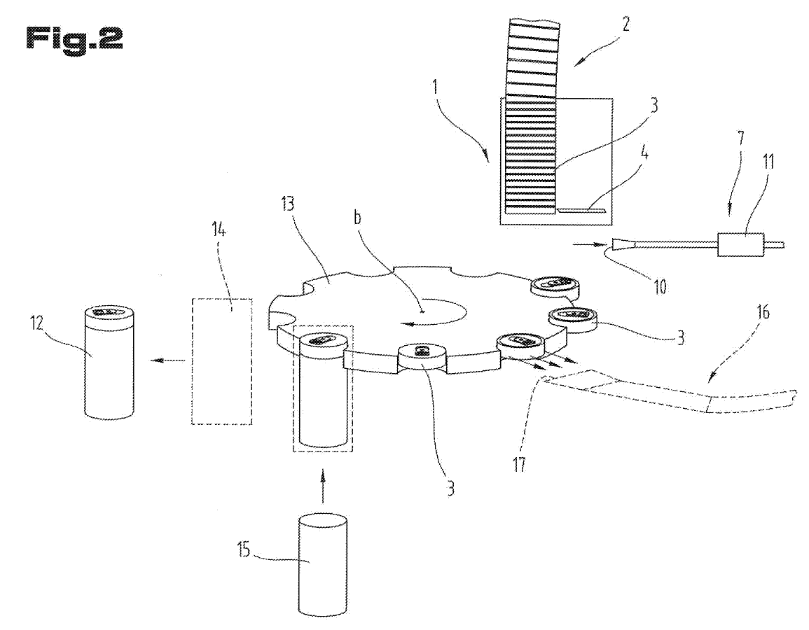

FIG. 2 a device for closing a can with the device illustrated in FIG. 1.

Firstly, it should be pointed out that the same parts described in the different embodiments are denoted by the same reference numbers and the same component names and the disclosures made throughout the description can be transposed in terms of meaning to same parts bearing the same reference numbers or same component names.

As illustrated in FIG. 1, a device 1 for separating can lids 3 disposed in a stack 2 comprises a separator blade 4. The can lids 3 may be made from sheet metal, for example aluminum sheet which may or may not be coated. The separator blade 4 may be provided in the form of a disk, for example made from metal, in particular steel, and is mounted so as to be rotatable on a shaft which rotates it during operation. The direction in which the separator blade 4 rotates about the shaft is indicated by an arrow in FIG. 1. The axis a of the separator blade 4 may be disposed to the side of the stack 2. The can lids 2 to be separated from the stack 3 are disposed above the separator blade 4 and are pressed against a surface of the separator blade by gravitational force. The lowermost can lid 3 of the stack 2 lies respectively at an outer edge of the separator blade 4 which has a recess 20 in its surface. As the separator blade 4 rotates, the lowermost can lid 3 in the stack 2 slides across an oblique surface 19 of the recess 20 onto a lower lying surface 21, from which it is moved across a surface 22 in the direction of a conveyor device indicated by reference 13 in FIG. 2. For example, a separated can lid 3 may drop onto the conveyor device 13.

At this stage, it should be noted that the separator blade 4 illustrated in FIG. 1 is merely an example of an embodiment of a separator blade and any other known designs of separator blade could also be used.

The device 1 further comprises one or more suction devices 5, 6, 7 for aspirating from the can lids 3 any particles caused by abrasion during separation of the can lid 3 and deposited on the can lids 3, for example. This abrasion may create metal dust, for example aluminum dust, which can occur due to a movement of the separator blade 4 relative to a can lid 3. The particles might also be dust particles disposed between adjacent can lids 3 which is released during the separation process. The device 1 may also be housed in a housing, although this is not illustrated, in order to prevent undesirable ingress by particles from the environment.

The suction device 5 has a suction orifice 8 disposed above the separator blade 4 in the vertical direction. The suction device 6 has a suction orifice 9 disposed at the height of the separator blade 4. Suction device 7, on the other hand, has a suction orifice 10 disposed underneath the separator blade 4. By preference, only one of the suction devices 5, 6 and 7 and one of the suction orifices 8, 9, 10 is provided on the device 1. However, the device 1 may also have several suction devices 5, 6, 7 and suction orifices 8, 9, 10. The suction orifices 8, 9, 10 may be provided in the form of openings or slots of nozzles through which air is sucked, for example. In this respect, it is of advantage if the suction takes place at a point from which the bottom faces of the can lids 3 are readily accessible.

As may be seen from FIG. 1, a portion of the suction orifice 8 overlaps a peripheral region of the disk. This enables particles to be efficiently aspirated from between the lowermost can lid 3 and the next can lid in the stack 2.

The suction device 5 may have a collecting container 11 for aspirated particles. The collecting container 11 may be disposed between the suction orifice 8 and a device for generating a flow, for example a pump or a fan. The collecting container 11 may have one or more filters 18 to prevent particles from escaping.

At this stage, it should be noted that other suction devices 7 and 8 could also be provided with co-operating collecting containers, although these are not illustrated here.

The method proposed by the invention will be described in more detail with reference to FIG. 2 illustrating the device.

In a step i), the lowermost can lid 3 in the stack 2 of can lids 3 is picked up and separated from the stack 2 by means of the separator blade 4.

In a step ii), the separated can lid 3 is conveyed by means of a conveyor device 13 to a device 14 for closing an open container 15 containing a product by means of the can lid. In the embodiment illustrated as an example, the conveyor device 13 is provided in the form of a star conveyor rotating about an axis b. The direction of rotation of the conveyor device 13 is indicated by an arrow in FIG. 2. The conveyor device 13 may be of a disk-shaped design and have holders for the separated can lids 3 at its peripheral regions. In these holders, the can lids 3 can then be conveyed to a position in which they can be placed on the containers 15, which are moved towards the conveyor device 13 from underneath, as illustrated in FIG. 2. The can lids 3 and the containers 15 are then connected to one another in a device 14 for closing the containers 15 to obtain the can 12 in a step iii). The device 14 may be a clinching device, for example. The containers 15 (open cans) are preferably made from a sheet metal, for example from a coated or non-coated aluminum sheet.

In step i) or between step i) and step ii), as the can lids 3 are separated by means of the separator blade 4, particles which occur due to abrasion are aspirated from at least one surface of the lowermost can lid 3 in the stack 2 of can lids 3 by means of the suction device 5, 6 or 7 illustrated in FIG. 1 in order to prevent the contents of a can from being contaminated by these particles.

As may be seen from FIG. 2, the bottom faces of the can lids 3 may be aspirated before they arrive at the conveyor device 14. As illustrated, this is done by means of suction device 5 with the suction orifice 10. However, it is also possible to provide at least one other suction device 16 with a suction orifice 17 disposed underneath the conveyor device 13 in order to aspirate the bottom faces of can lids 2 disposed in the conveyor device 13. Accordingly, particles occurring on the can lids 3 due to abrasion during the separation process can be aspirated both during and after step i).

The aspirated particles can be collected in the collecting container 11 and analyzed during another step.

For the sake of good order, finally, it should be pointed out that in order to provide a clearer understanding of the structure of the device proposed by the invention, it and its constituent parts are illustrated to a certain extent out of scale and/or on a larger scale and/or on a smaller scale.

### LIST OF REFERENCE NUMBERS

1 Device

2 Stack

3 Can lid

4 Separator blade

5 Suction device

6 Suction device

7 Suction device

8 Suction orifice

9 Suction orifice

10 Suction orifice

11 Collecting container

12 Can

13 Conveyor device

14 Device

15 Container

16 Suction device

17 Suction orifice

18 Filter

a Axis

b Axis

1. Device (1) for separating can lids (3) disposed in a stack (2) by means of a separator blade (4), wherein the device (1) comprises at least one suction device (5, 6, 7) for aspirating from the can lids (3) particles released during the process of separating the can lid (3).

2. Device according to claim 1, wherein at least one suction orifice (8, 9, 10) of the at least one suction device (5, 6, 7) is disposed at least partially above or underneath the separator blade (4), as viewed in a vertical direction, or at the same height as the separator blade (4).

3. Device according to claim 2, wherein separator blade (4) is provided in the form of a disk mounted so as to be rotatable about an axis (a) and at least a portion of the suction orifices (8) overlaps at least a peripheral region of the disk as viewed in a direction parallel with the axis (a).

4. Device according to claim 1, wherein the at least one suction device (5) has a collecting container (11) for aspirated particles.

5. Method of closing an open container (15) with a can lid (3) to obtain a closed can (12), whereby in a step i), a lowermost can lid (3) in a stack (2) of can lids (3) is picked up and separated from the stack (2) by means of a separator blade (4), and in a step ii), the separates can lid (3) is conveyed by means of at least one conveyor device (13) to a device (14) for closing the open container (15) with the can lid (3), and in a step iii), the container (15) is connected to the can lid (3) to obtain the can (12), wherein in step i) or between step i) and step ii), particles occurring on the can lids (3) during the separation process by of means of the separator blade (4) are aspirated from at least one surface of the lowermost can lid (3) in the stack (2).

6. Method according to claim 5, wherein in step i), particles occurring during the process of separating the can lid (3) by means of the separator blade (4) are aspirated from a gap between lowermost can lid (3) in the stack (2) and the next can lid (3) in the stack (2).

7. Method according to claim 5, wherein during step i), particles are aspirated from at least the bottom face of the lowermost can lid (3) in the stack (2).

8. Method according to claim 5, wherein after step i), particles are aspirated from at least the bottom face of the can lid (3) separated in step i).

9. Method according to claim 5, wherein the particles aspirated in or after step i) are collected in a collecting container (11).

10. Method according to claim 9, wherein in particles collected in the collecting container (11) are analyzed.
